(19) United States
(12) Patent Application Publication
(10) Pub. No.: US 2013/0306107 A1
(43) Pub. Date: Nov. 21, 2013

(54) Vacuum Attachment System

(71) Applicant: Matthew Jensen, Sweet Home, OR (US)

(72) Inventor: Matthew Jensen, Sweet Home, OR (US)

(21) Appl. No.: 13/475,885

(22) Filed: May 18, 2012

(51) Int. Cl. A47L 9/00; B08B 5/04

(52) U.S. Cl. 134/21; 15/246.2

(57) ABSTRACT

In accordance with one or more aspects, a vacuum attachment system for removing debris is disclosed. The system contains attachments that attach to a vacuum device and are specifically designed for particular cleaning purposes. The attachment system can be used for residential, commercial, or automotive cleaning applications. Scraping blades at the end of the attachments are used to loosen stuck-on debris; the debris then being removed by the suction force created by the vacuum device.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

1. Field of the Invention

The present invention relates to the attachments located on one end of a vacuum hose, and to be used with a vacuuming device, more specifically those attachments with specific cleaning purposes such as, but not limited to, scraping, cutting, scratching, etching, and all other modalities of workmanship.

2. Description of the Related Art

Vacuum cleaning systems are a common feature in most households, and many businesses. The concept of a vacuum device is to use suction in order to remove material from one area and deposit the material into a receptacle for ease of transport or disposal. This material can range from microscopic dust particles to much larger items such as leaves or building materials.

Most vacuum devices use a motor to spin a fan in order to draw air particles into an intake port and pass the particles out through an exhaust port. Most systems will have a porous filter with pores large enough to allow air particles through, but small enough to block the passage of vacuumed material. As a result of moving air particles, the area near intake port has a much lower air pressure than that of the ambient atmosphere, and draws a large amount of air particles into the intake. This movement of particles creates friction on any material in the vicinity of the intake. Small or loose pieces of material will succumb to the friction of the air particles colliding into them, and be drawn into the air current advancing towards, then into, the intake port.

Upon entering the intake, canister vacuums feature a larger open area where the stream of air particles slows down. Due to the slower air speed, vacuumed materials fall out of this particle stream and into the receptacle. There are many variations of this system and include, but are not limited to, bag-filter type systems in which the material is collected in a porous bag for removal or disposal, and centrifugal systems that use a spinning unit in place of the bag.

In a conventional vacuuming system, a hose is attached to a receptacle and once a vacuum has been introduced, it is then transferred to said hose and suction is created in the environment at the open end of the hose. The open end of the hose opposite from the receptacle generally accepts various attachments that perform different tasks. A larger opening increases the effective surface area of the attachment and can cut down on the amount of time spent using the vacuum. A smaller opening on the attachment reduces the surface area, but increases the speed of the air particles entering the opening, and in turn, increases suction forces.

Many of these attachments are used in workshops, construction sites, and other activities that require vacuuming systems to remove material produced by the use of tools. The present invention would not only satisfy the need of vacuuming, but also perform the tasks done by those tools that produce the materials to be vacuumed. The attachments will have those features in the same proximity as the suction produced by the hose, effectively escorting the material directly into the intake port of the vacuum. This is highly desirable, as the user will not have to operate the vacuum and the tool independently, effectively saving time and avoiding potential injury.

### BRIEF SUMMARY OF THE INVENTION

Exemplary embodiments are disclosed to provide a vacuum attachment system. The vacuum attachment system can provide multiple vacuum attachments, each of which can be used for a particular cleaning purpose. The vacuum attachments can be affixed to the end of a vacuum suction hose or tube for removing debris.

In a preferred embodiment of the present invention, a vacuum attachment system may be comprised of multiple attachments, each attachment designed for a particular cleaning purpose. The attachments may have an attachment end that is of uniform size for connecting with a vacuuming tube or hose. The attachments may have a tip that is designed and constructed to meet a specific vacuuming need.

According to another preferred embodiment of the present invention, the vacuuming attachment system may have attachments specifically intended for use in a construction setting. An attachment in the vacuuming system may have a detachably attached cutting blade for scraping away paint overspray from windows or other glass surfaces. Another attachment in the vacuuming system may have a serrated edge for removing stuck-on debris from floors or walls. By way of example, the serrated edge may be used to loosen and remove drywall mud from floors.

According to another preferred embodiment of the present invention, the vacuuming attachment system may have attachments specifically intended for use in an automotive setting. An attachment in the vacuuming system may have a narrowed vacuuming end with a detachably attached cutting blade for removing head gaskets from an engine block or the cylinder head of an internal combustion engine.

According to another preferred embodiment of the present invention, the vacuuming attachment system may have attachments specifically intended for use in a commercial setting. An attachment in the vacuuming system may have removable scraping blades that could be sharpened and reinserted into the vacuum attachment. Another attachment in the vacuuming system may have one or more grating surfaces that could be used to remove paper, glue, or other material from walls, ceilings, windows, or floors.

According to another preferred embodiment of the present invention, the vacuuming attachment system may have integrated or removable scraping blades for removing stuck-on or difficult-to-remove debris. The integrated or removable scraping blades may be made of metal or plastic. A plastic removable scraping blade may be used to avoid scratching floors, countertops, or other soft materials from which debris must be removed.

The vacuum attachments described in the exemplary embodiments are not limited to the purposes set forth in each example. The teachings of the exemplary embodiments are not intended to limit the invention to those embodiments, but are merely set forth to illustrate how the vacuuming system may be used in a particular setting. It is understood that those skilled in the art may use the vacuuming system attachments for purposes other than those mentioned in the exemplary embodiment.

### BRIEF DESCRIPTION OF THE SEVERAL VIEWS OF THE DRAWING(S)

FIG. 1 is a block diagram of an exemplary method for using a vacuum attachment system as according to one embodiment of the present invention;

FIG. 2 is a side view of an exemplary vacuum attachment as according to one embodiment of the present invention;

FIG. 3A is a top view of the tip of an exemplary vacuum attachment with an integrated scraping blade as according to one embodiment of the present invention;

FIG. 3B is a side view of the tip of an exemplary vacuum attachment with an integrated scraping blade as according to one embodiment of the present invention;

FIG. 4A is a top view of the tip of an exemplary vacuum attachment with a separable scraping blade as according to one embodiment of the present invention;

FIG. 4B is a side view of the tip of an exemplary vacuum attachment with a separable scraping blade as according to one embodiment of the present invention;

FIG. 5A is a top view of the tip of an exemplary vacuum attachment with a serrated scraping edge as according to one embodiment of the present invention;

FIG. 5B is a side view of the tip of an exemplary vacuum attachment with a serrated scraping edge as according to one embodiment of the present invention;

FIG. 6A is a top view of the tip of an exemplary vacuum attachment with corner scraping edges as according to one embodiment of the present invention;

FIG. 6B is a side view of the tip of an exemplary vacuum attachment with corner scraping edges as according to one embodiment of the present invention;

FIG. 7A is a top view of the tip of an exemplary vacuum attachment with a curved suction nozzle as according to one embodiment of the present invention;

FIG. 7B is a side view of the tip of an exemplary vacuum attachment with a curved suction nozzle as according to one embodiment of the present invention;

FIG. 8A is a top view of the tip of an exemplary vacuum attachment with a right-angle suction nozzle as according to one embodiment of the present invention;

FIG. 8B is a side view of the tip of an exemplary vacuum attachment with a right-angle suction nozzle as according to one embodiment of the present invention;

FIG. 9A is a top view of the tip of an exemplary vacuum attachment with a fanned suction nozzle as according to one embodiment of the present invention;

FIG. 9B is a side view of the tip of an exemplary vacuum attachment with a fanned suction nozzle as according to one embodiment of the present invention;

FIG. 10A is a top view of the tip of an exemplary vacuum attachment with scraping holes as according to one embodiment of the present invention;

FIG. 10B is a side view of the tip of an exemplary vacuum attachment with scraping holes as according to one embodiment of the present invention;

FIG. 11A is a top view of the tip of an exemplary corner vacuum attachment with scraping holes as according to one embodiment of the present invention; and

FIG. 11B is a side view of the tip of an exemplary corner vacuum attachment with scraping holes as according to one embodiment of the present invention.

FIG. 12 is a top view of an exemplary vacuum attachment with a widened suction nozzle as according to one embodiment of the present invention.

FIG. 13 is a side view of the tip of an exemplary vacuum attachment with a permanent scraping blade as according to one embodiment of the present invention.

FIG. 14 is a side view of an exemplary vacuum attachment as according to one embodiment of the present invention.

FIG. 15A is a top view of an exemplary corner vacuum attachment with a scraping blade as according to one embodiment of the present invention.

FIG. 15B is a side view of an exemplary corner vacuum attachment with a scraping blade as according to one embodiment of the present invention.

FIG. 16 is a cross-sectional view of an exemplary vacuum attachment with a tapered section as according to one embodiment of the present invention.

FIG. 17 is a cross-sectional view of an exemplary vacuum attachment with a tapered section as according to one embodiment of the present invention.

FIG. 18 is a top view of an exemplary vacuum attachment with a narrowed suction nozzle as according to one embodiment of the present invention.

A further understanding of the present invention can be obtained by reference to a preferred embodiment set forth in the illustrations of the accompanying drawings. Although the illustrated embodiment is merely exemplary of methods for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

The terms “vacuum attachment system”, “vacuum attachment”, and “attachment” may be used interchangeably herein to refer to the present invention. Although the following description and claims may refer to components of the system in the singular, such as a vacuum attachment, it is understood that the references may also include components of the system in the multiple.

Several preferred embodiments of the vacuum attachment system are discussed in this section. However, the invention is not limited to these embodiments. A vacuum attachment system is any combination of vacuum attachments that are used to remove debris. The system is not limited in method of removal, dimensions of attachments, types of vacuums that may be used with the attachments, or size of suction tubes to which the attachments are attached.

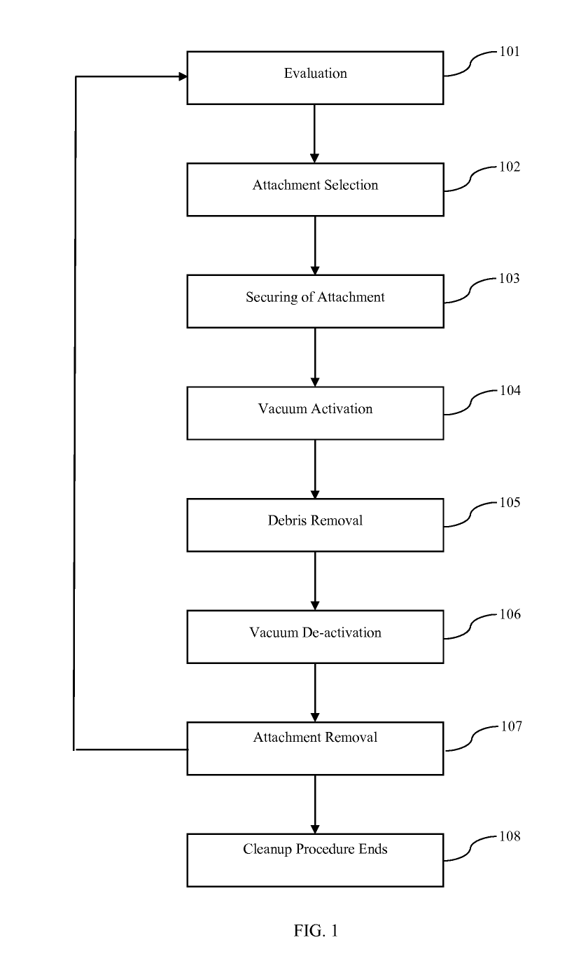

Referring now to FIG. 1, there is shown a block diagram of an exemplary method for using a vacuum attachment system as according to one embodiment of the present invention. A user of the system may evaluate (101) the cleanup job by assessing the location and nature of the debris to be removed. After evaluating (101) the cleanup job, the user may select an appropriate attachment (102) from the available attachments to use for removing the debris. The user may then secure the vacuum attachment (103) to a vacuum tube or hose that is, in turn, attached to a vacuum device. After securing the attachment (103), the user may activate the vacuum device (104) in order to create a suction force through the vacuum attachment. With the vacuum activated (104), the user may begin removing debris (105) by placing the vacuum attachment in sufficiently close proximity as to allow the suction force to transport the debris through the vacuum attachment into the vacuum device. Once the cleanup job is done, the user may de-activate the vacuum device (106) by turning off or unplugging the device. After the device de-activated (106), the user may remove the attachment (107) from the suction tube or hose, or may re-evaluate (101) the same or another area that needs to be cleaned. If the same or another area requires cleaning, the user may repeat steps 101-107 for as many times as necessary. Once there are no more areas requiring cleaning, the cleanup procedure ends (108).

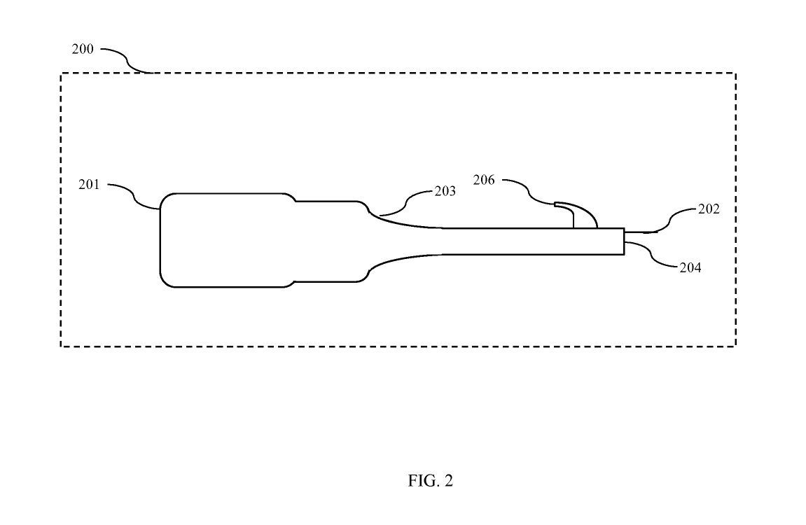

Referring now to FIG. 2, there is shown a side view of the tip of an exemplary vacuum attachment (200) as according to one embodiment of the present invention. The vacuum attachment (200) has an open receptacle area for receiving a vacuum tube or hose (201). The attachment may be tapered (203) so as to increase the force of suction created by a vacuum device. The vacuum attachment (200) may have a release mechanism (206) that can be lifted to disengage a removable scraping blade (202). The removable scraping blade (202) can be used to scrape stuck-on debris off of a surface that requires cleaning. The removable scraping blade (202) may be made of metal or plastic. A plastic removable scraping blade (202) may be used to avoid scratching floors, countertops, or other soft materials from which debris must be removed. Debris may be sucked into the vacuum attachment (200) through a suction opening (204) and transported to the vacuum device.

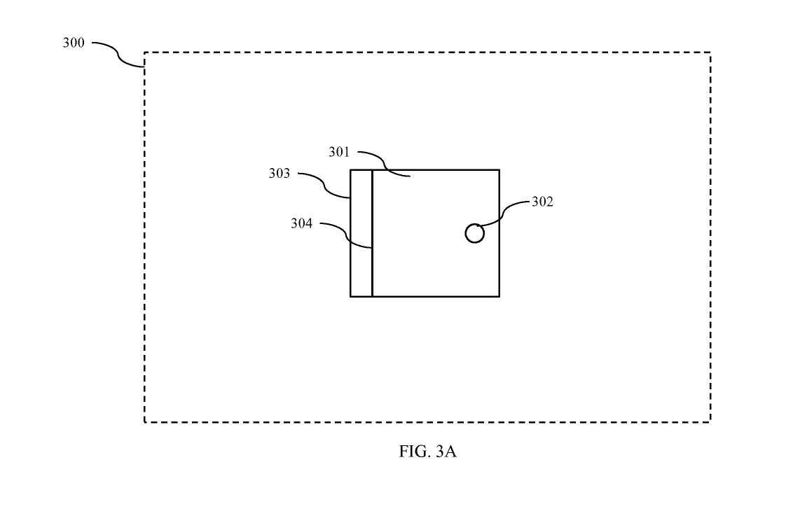

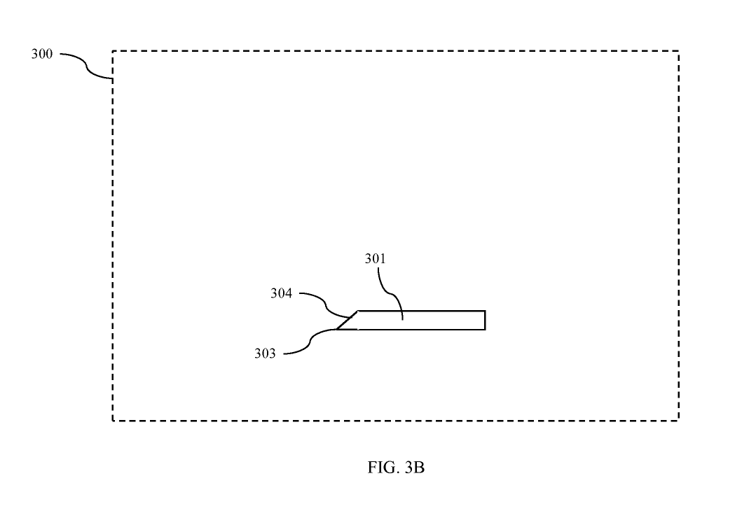

Referring now to FIGS. 3A and 3B that will be discussed together, there is shown the tip of an exemplary vacuum attachment (300) with an integrated scraping blade (303) as according to one embodiment of the present invention. The integrated scraping blade (303) may be made of metal or plastic. A plastic integrated scraping blade (303) may be used to avoid scratching floors, countertops, or other soft materials from which debris must be removed. The vacuum attachment tip (300) may have a release mechanism (302) for releasing detachable blades, even though detachable blades may not be used with attachments possessing integrated blades (303). The attachment (300) may have an opening (304) through which debris are removed by suction force. A user may hold the attachment (300) by gripping the attachment body (301).

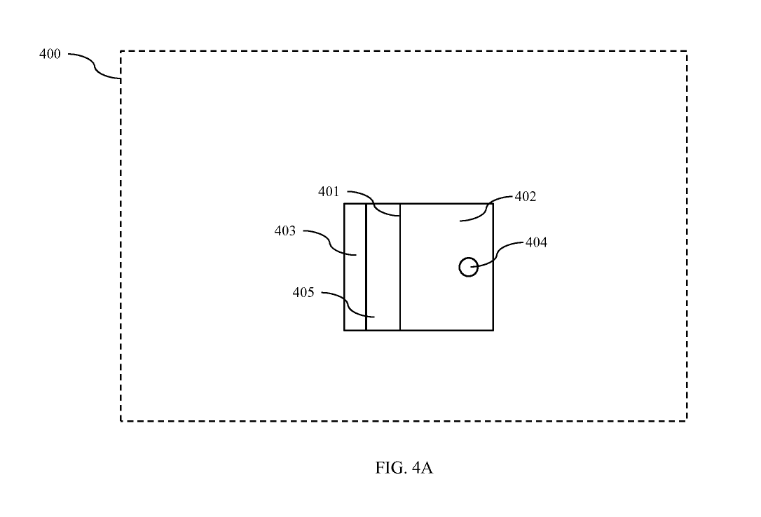

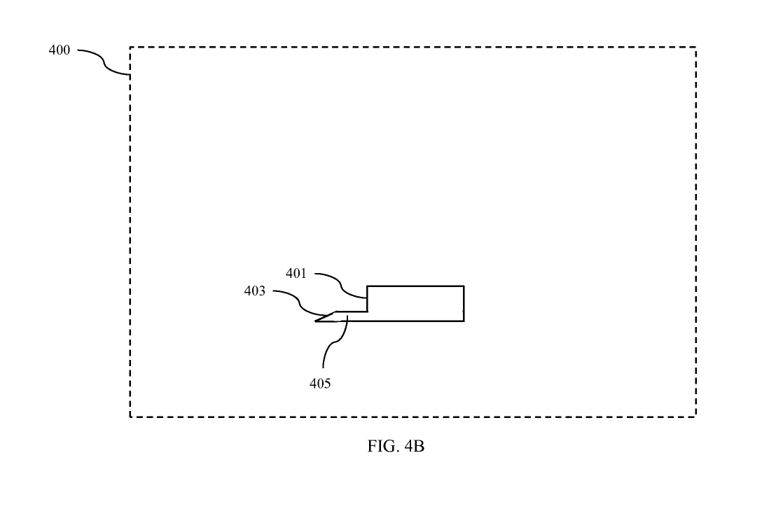

Referring now to FIGS. 4A and 4B that will be discussed together, there is shown the tip of an exemplary vacuum attachment (400) with a separable scraping blade (405) as according to one embodiment of the present invention. The separable scraping blade (405) may have a sharpened edge (403) for cutting through stuck-on debris. The separable scraping blade (405) may be made of metal or plastic. A plastic separable scraping blade (405) may be used to avoid scratching floors, countertops, or other soft materials from which debris must be removed. The tip of the vacuum attachment (400) may have an opening (401) through which debris are removed by suction force. A release mechanism (404) may be used to release the separable scraping blade (405).

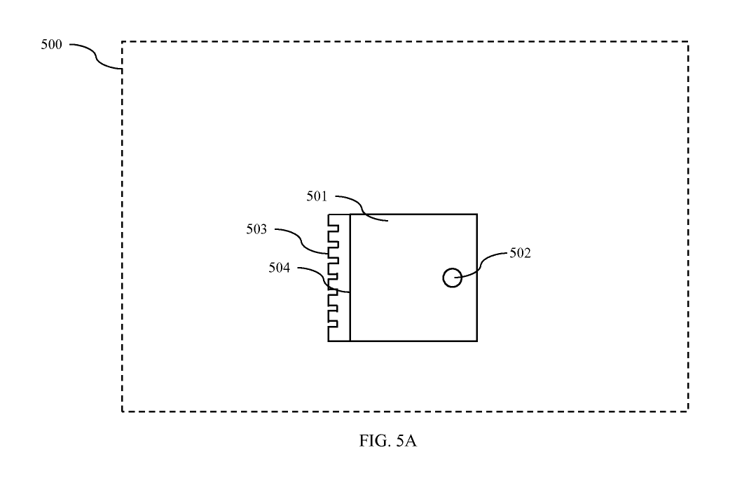

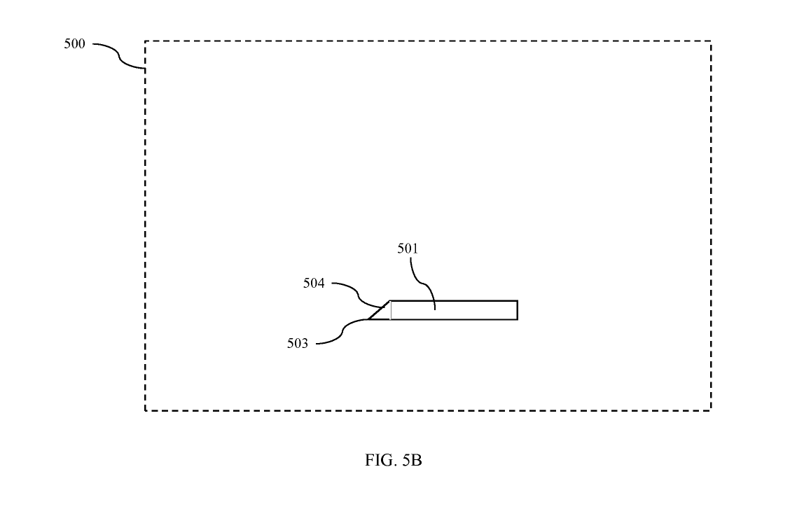

Referring now to FIGS. 5A and 5B that will be discussed together, there is shown the tip of an exemplary vacuum attachment (500) with a serrated scraping edge (503) as according to one embodiment of the present invention. The tip of the vacuum attachment (600) may have an integrated or removable serrated scraping edge (503) for loosening stuck-on debris. The serrated scraping blade (503) may be made of metal or plastic. A plastic serrated scraping blade (503) may be used to avoid scratching floors, countertops, or other soft materials from which debris must be removed. The tip of the vacuum attachment (500) may have a release mechanism (502) for releasing detachable blades, even though detachable blades may not be used with attachments possessing integrated blades. The attachment tip (500) may have an opening (504) through which debris are removed by suction force. A user may hold the attachment tip (500) by gripping the attachment body (501).

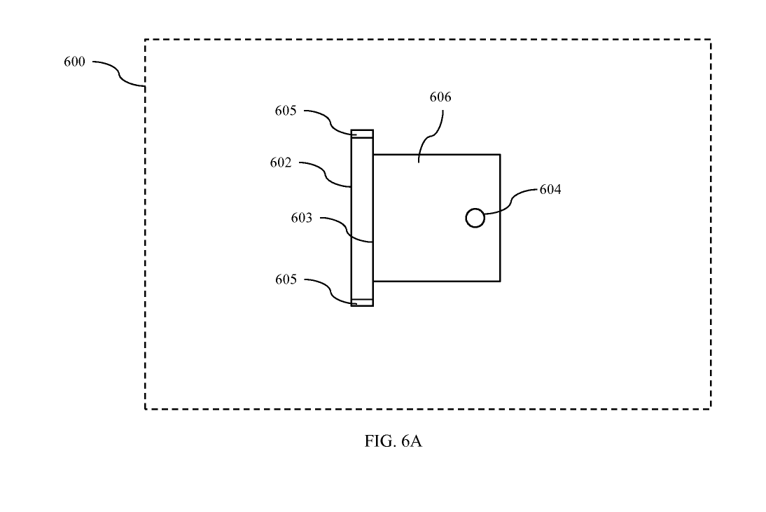

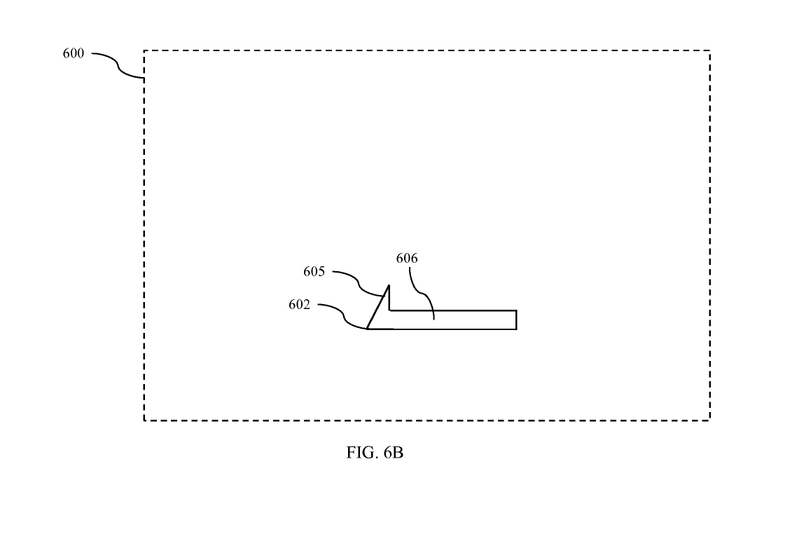

Referring now to FIGS. 6A and 6B that will be discussed together, there is shown the tip of an exemplary vacuum attachment (600) with corner scraping edges (605) as according to one embodiment of the present invention. The tip of the vacuum attachment (600) may have an integrated or removable scraping blade (602) for loosening stuck-on debris. The tip of the vacuum attachment (600) may have a release mechanism (604) for releasing detachable blades, even though detachable blades may not be used with attachments possessing integrated blades (602). The attachment tip (600) may have an opening (603) through which debris are removed by suction force. A user may hold the attachment tip (600) by gripping the attachment body (606).

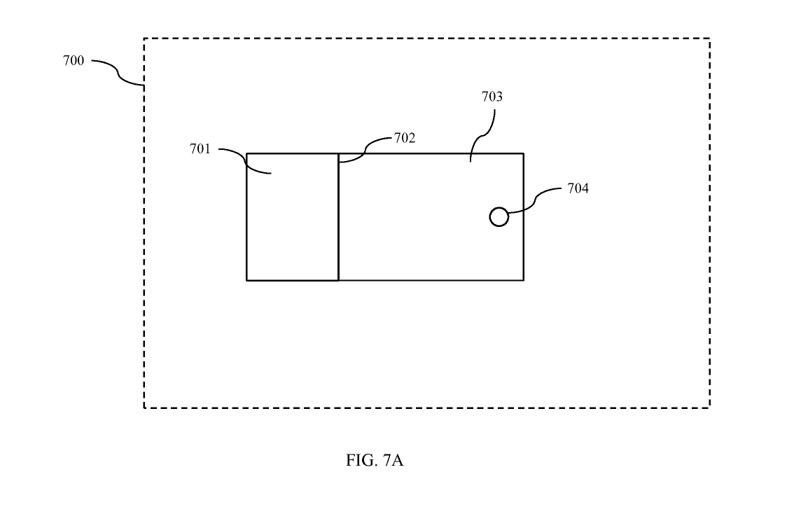

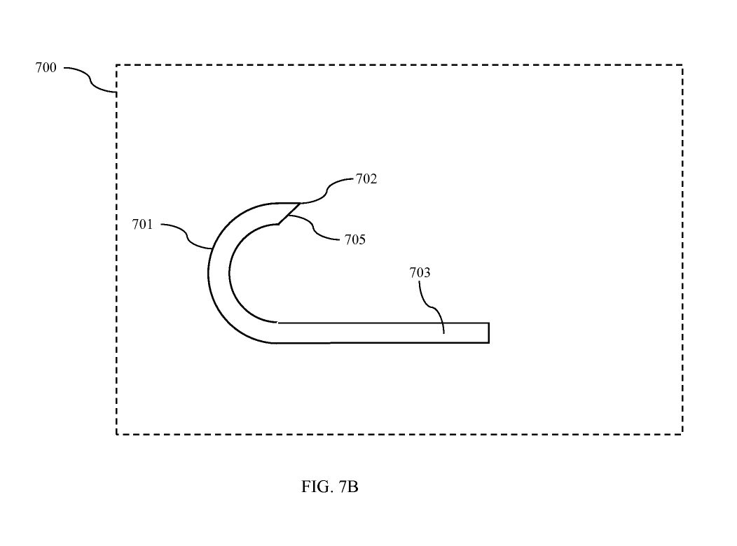

Referring now to FIGS. 7A and 7B that will be discussed together, there is shown the tip of an exemplary vacuum attachment (700) with a curved suction nozzle (701) as according to one embodiment of the present invention. The tip of the vacuum attachment (700) may have an integrated or removable scraping blade (702) for loosening stuck-on debris. The tip of the vacuum attachment (700) may have a release mechanism (704) for releasing detachable blades, even though detachable blades may not be used with attachments possessing integrated blades. The attachment tip (700) may have an opening (705) through which debris are removed by suction force. A user may hold the attachment tip (700) by gripping the attachment body (703).

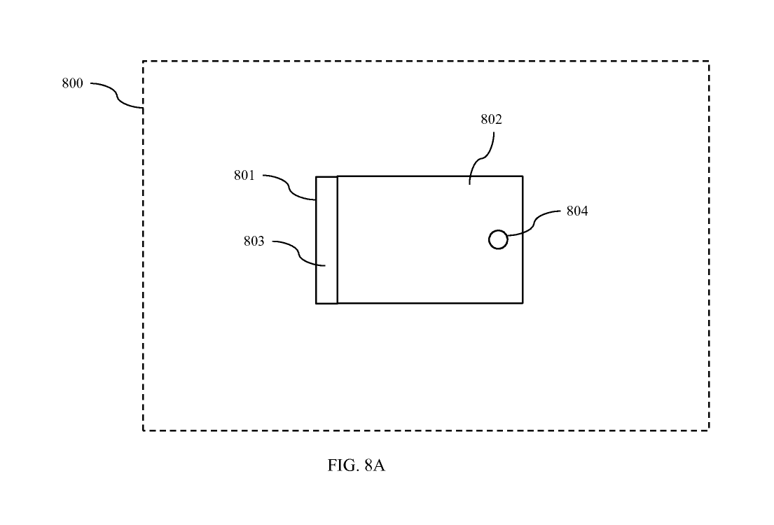

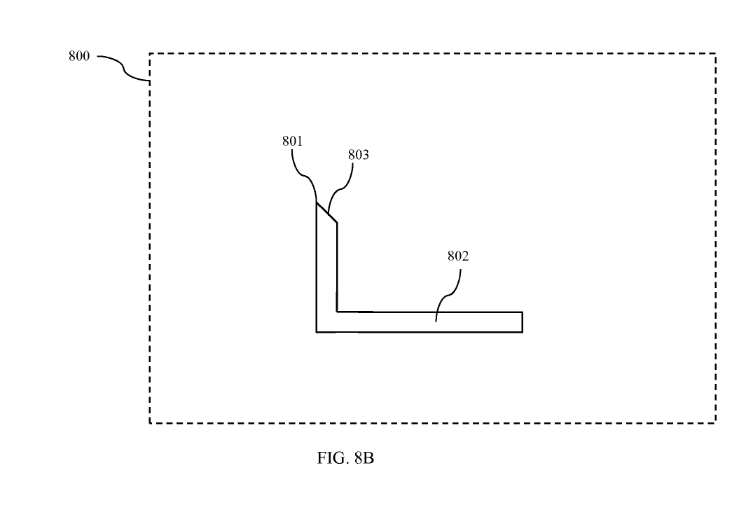

Referring now to FIGS. 8A and 8B that will be discussed together, there is shown the tip of an exemplary vacuum attachment (800) with a right-angle suction nozzle as according to one embodiment of the present invention. The tip of the vacuum attachment (800) may have an integrated or removable scraping blade (801) for loosening stuck-on debris. The tip of the vacuum attachment (800) may have a release mechanism (804) for releasing detachable blades, even though detachable blades may not be used with attachments possessing integrated blades. The attachment tip (800) may have an opening (803) through which debris are removed by suction force. A user may hold the attachment tip (800) by gripping the attachment body (802).

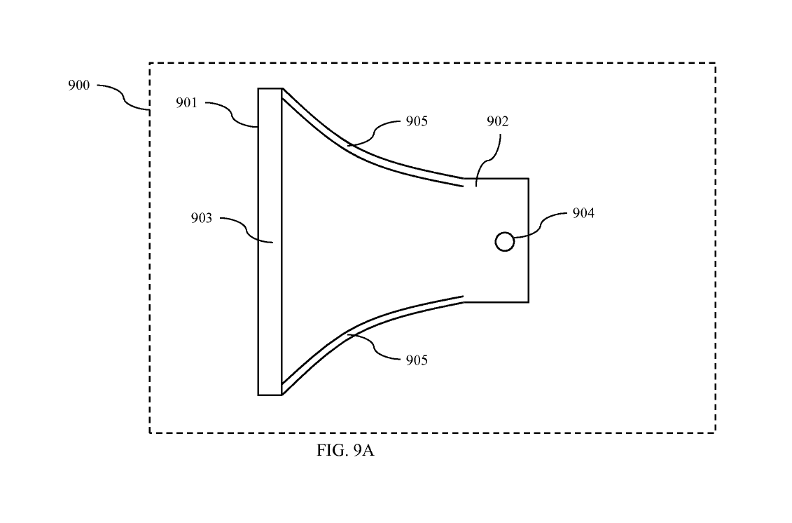

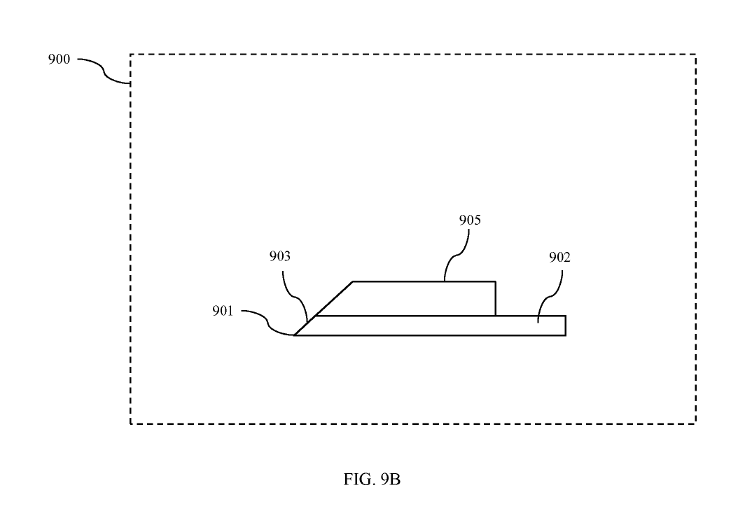

Referring now to FIGS. 9A and 9B that will be discussed together, there is shown the tip of an exemplary vacuum attachment (900) with a fanned suction nozzle as according to one embodiment of the present invention. The tip of the vacuum attachment (900) may have an integrated or removable scraping blade (901) for loosening stuck-on debris. The tip of the vacuum attachment (900) may have a release mechanism (904) for releasing detachable blades, even though detachable blades may not be used with attachments possessing integrated blades. The attachment tip (900) may have an opening (903) through which debris are removed by suction force. The tip of the vacuum attachment (900) may have side walls (905) for guiding debris into the opening (903) through which debris are removed. A user may hold the attachment tip (900) by gripping the attachment body (902).

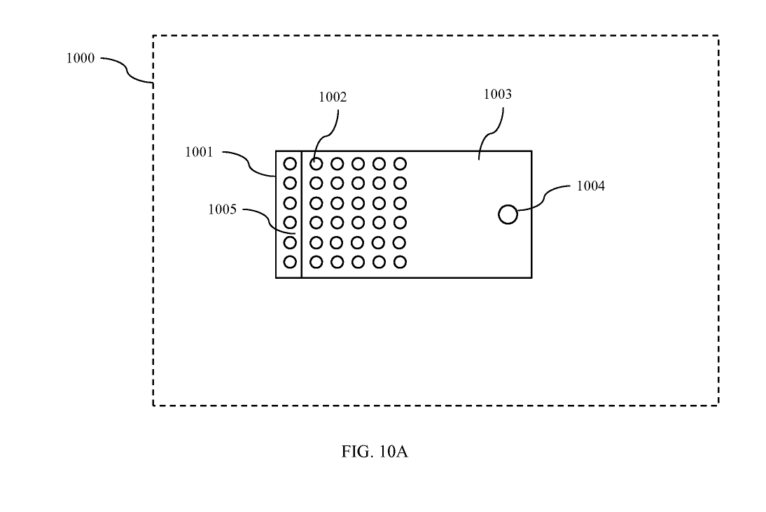

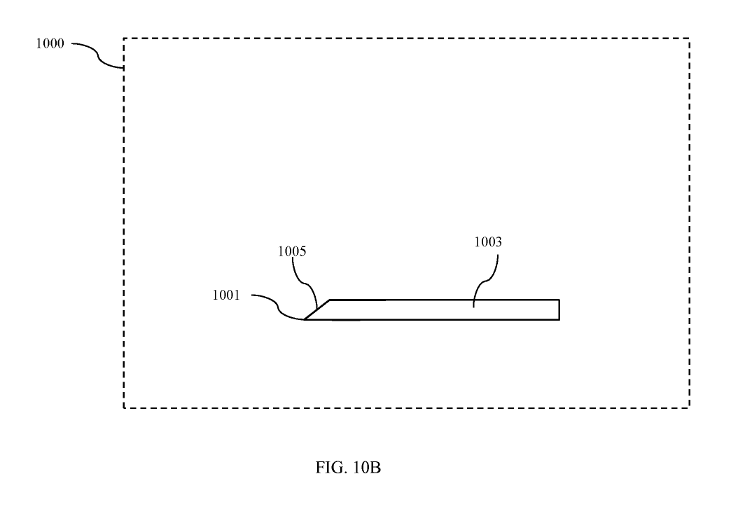

Referring now to FIGS. 10A and 10B that will be discussed together, there is shown the tip of an exemplary vacuum attachment (1000) with scraping holes (1002) as according to one embodiment of the present invention. The scraping holes (1002) may be used by rubbing the tip of the vacuum attachment (1000) against stuck-on debris in a grating manner to loosen and remove the debris. The tip of the vacuum attachment (1000) may have an integrated or removable scraping blade (1001) for loosening stuck-on debris. The tip of the vacuum attachment (1000) may have a release mechanism (1004) for releasing detachable blades, even though detachable blades may not be used with attachments possessing integrated blades. The attachment tip (1000) may have an opening (1005) through which debris are removed by suction force. A user may hold the attachment tip (1000) by gripping the attachment body (1003).

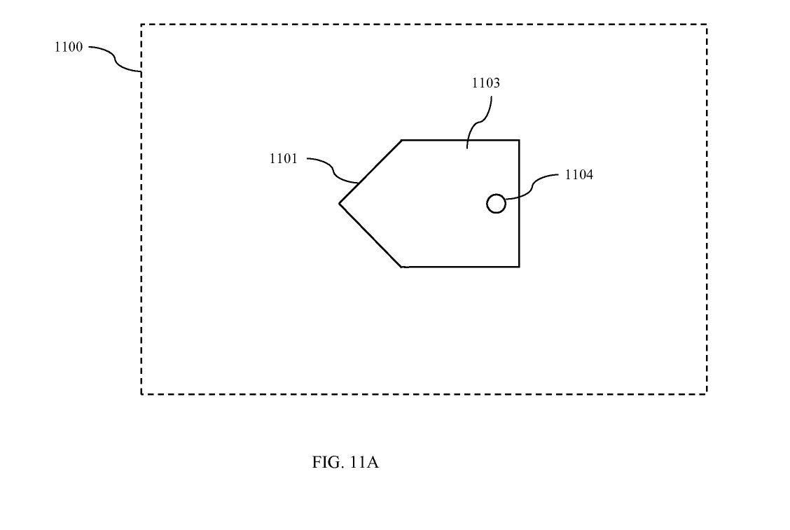

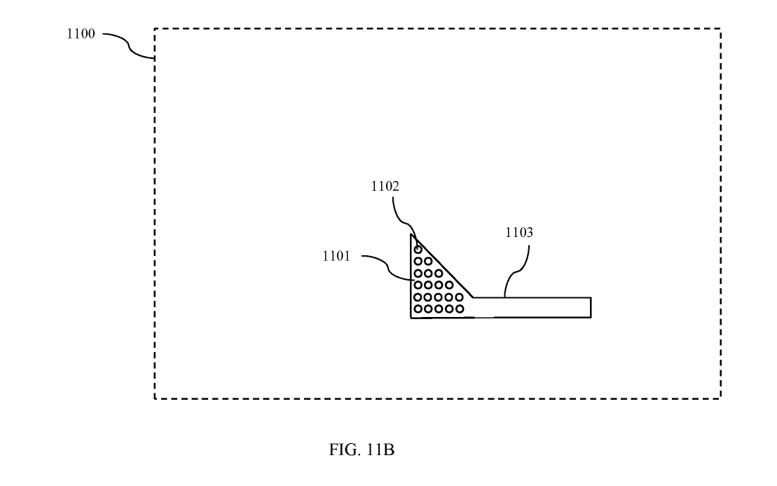

Referring now to FIGS. 11A and 1 lB that will be discussed together, there is shown the tip of an exemplary corner vacuum attachment (1100) with scraping holes (1102) as according to one embodiment of the present invention. The scraping holes (1102) may be used by rubbing the tip of the vacuum attachment (1100) against stuck-on debris in a grating manner to loosen and remove the debris. The tip of the vacuum attachment (1100) may have a housing (1101) angled in such a way as to allow for easy cleaning of corners or areas where building surfaces meet. The tip of the vacuum attachment (1100) may have a release mechanism (1104) for releasing detachable blades, even though detachable blades may not be used with attachments possessing integrated blades. A user may hold the attachment tip (1100) by gripping the attachment body (1103).

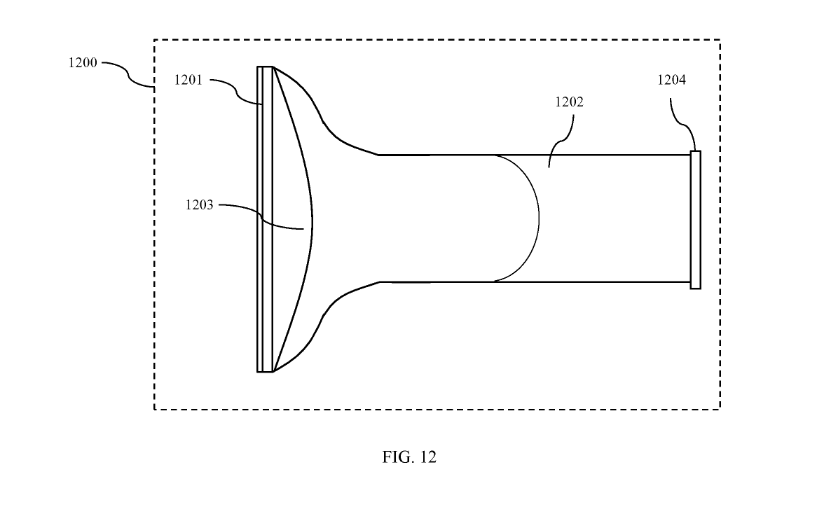

Referring now to FIG. 12, there is shown an exemplary vacuum attachment (1200) with a widened suction nozzle as according to one embodiment of the present invention. The vacuum attachment (1200) may have an integrated or removable scraping blade (1201) for loosening stuck-on debris. The vacuum attachment (1200) may have a collar (1204) for attaching the vacuum attachment (1200) to a suction tube or hose. The vacuum attachment (1200) may have an opening (1203) through which debris are removed by suction force. A user may hold the attachment (1200) by gripping the attachment body (1202).

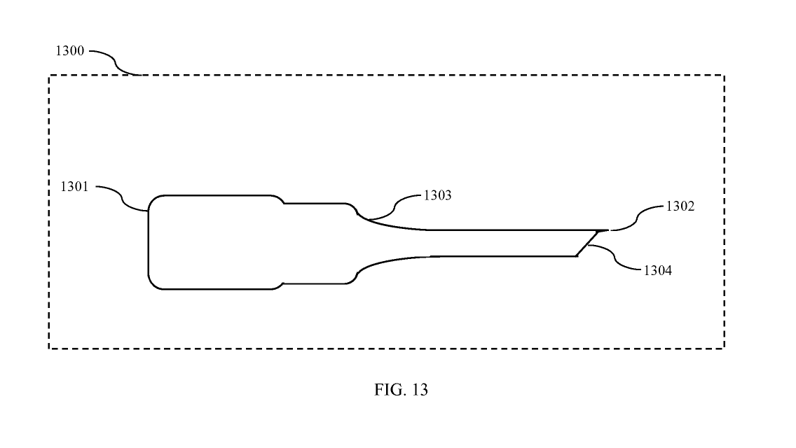

Referring now to FIG. 13, there is shown a side view of the tip of an exemplary vacuum attachment (1300) with a permanent scraping blade (1302) as according to one embodiment of the present invention. The tip of the vacuum attachment (1300) may have an open receptacle area for receiving a vacuum tube or hose (1301). The attachment may be tapered (1303) so as to increase the force of suction created by a vacuum device. The permanent scraping blade (1302) can be used to scrape stuck-on debris off of a surface that requires cleaning Debris may be sucked into the vacuum attachment (1300) through a suction opening (1304) and transported to the vacuum device.

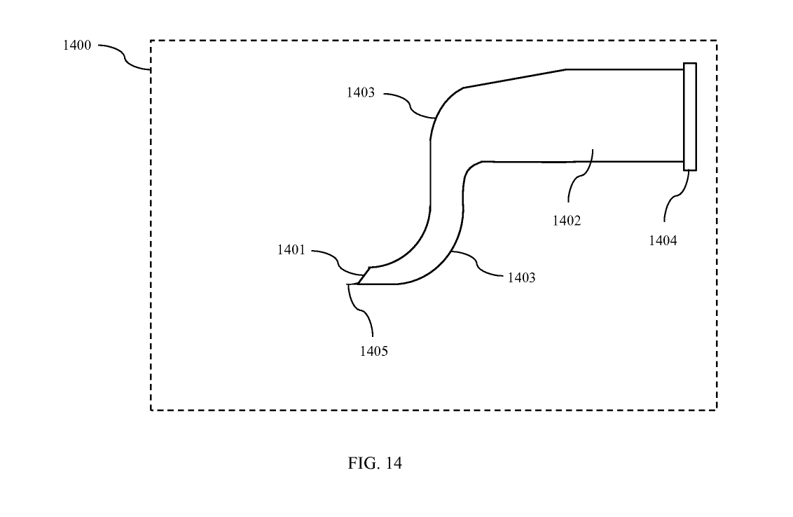

Referring now to FIG. 14, there is shown a side view of an exemplary vacuum attachment (1400) with curved sections (1403) as according to one embodiment of the present invention. The vacuum attachment (1400) may have curved sections (1403) so that the vacuum attachment may access difficult-to-reach debris. Debris may be sucked into the vacuum attachment (1400) through a suction opening (1401) and transported to the vacuum device. A user may hold the attachment (1400) by gripping the body of the attachment (1402). The vacuum attachment (1400) may have an integrated or removable scraping blade (1405) for loosening stuck-on debris. The vacuum attachment (1400) may have a collar (1404) for attaching the vacuum attachment (1400) to a suction tube or hose. The exact size, shape, and dimensions of the vacuum attachment (1400) may be variable in order to meet the requirements of different cleaning applications. Furthermore, the curved sections (1403) of the vacuum attachment (1400) may be curved to variable degrees of curvature in order to meet the requirements of different cleaning applications.

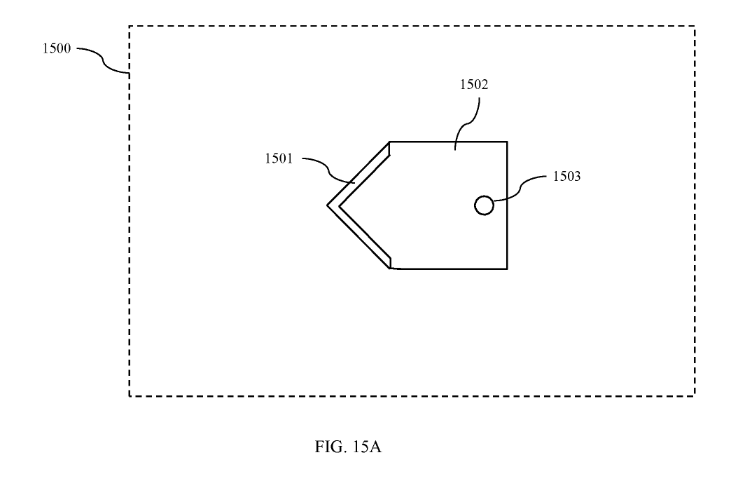

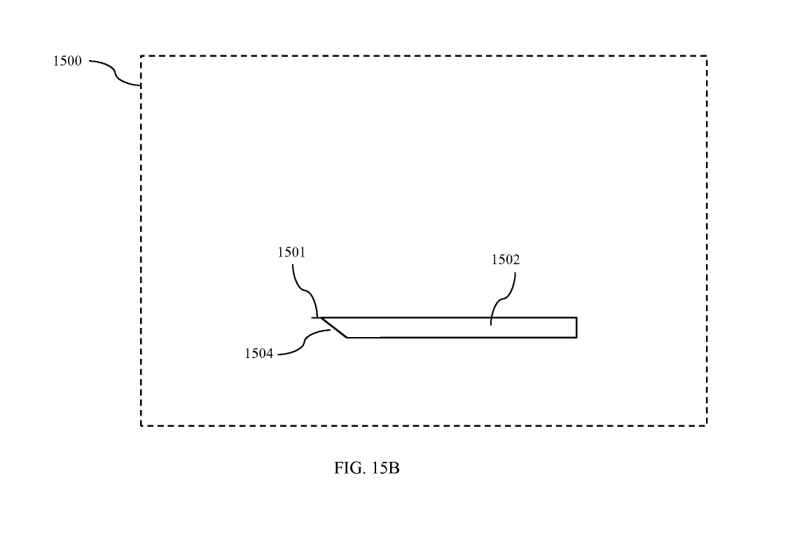

Referring now to FIGS. 15A and 15B that will be discussed together, there is shown the tip of an exemplary corner vacuum attachment (1500) with a scraping blade (1501) as according to one embodiment of the present invention. The scraping blade (1501) may be used by rubbing the scraping blade (1501) against stuck-on debris to loosen and remove the debris. Debris may be transported to a suction device by suction force through an opening (1504) in the tip of the vacuum attachment (1500). The tip of the vacuum attachment (1500) may have a housing (1502) angled in such a way as to allow for easy cleaning of corners or areas where building surfaces meet. The tip of the vacuum attachment (1500) may have a release mechanism (1503) for releasing detachable blades, even though detachable blades may not be used with attachments possessing integrated blades. A user may hold the attachment tip (1500) by gripping the attachment body (1502).

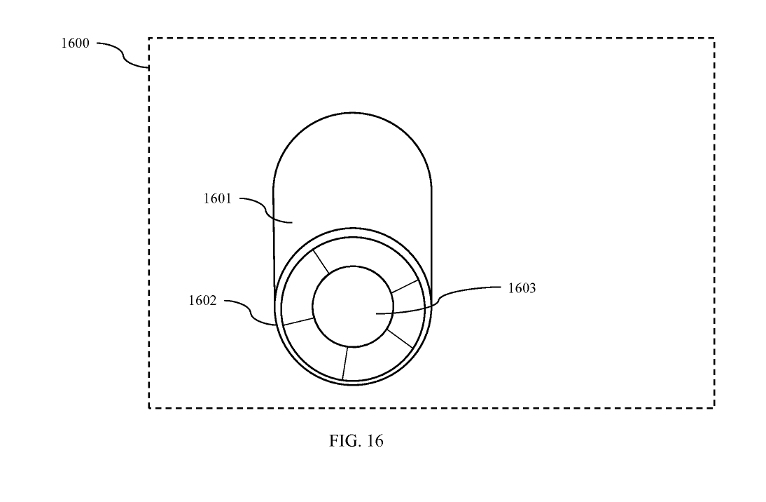

Referring now to FIG. 16 there is a cross-sectional view of a vacuum attachment (1600) with a tapered section as according to one embodiment of the present invention. The vacuum attachment (1600) may have tube section (1601) with an outer wall (1602) that tapers down to accommodate vacuum tubes or hoses with a smaller diameter. Debris may be transported through the vacuum attachment (1600) by travelling in a reduced-diameter opening (1603) within the vacuum attachment (1600).

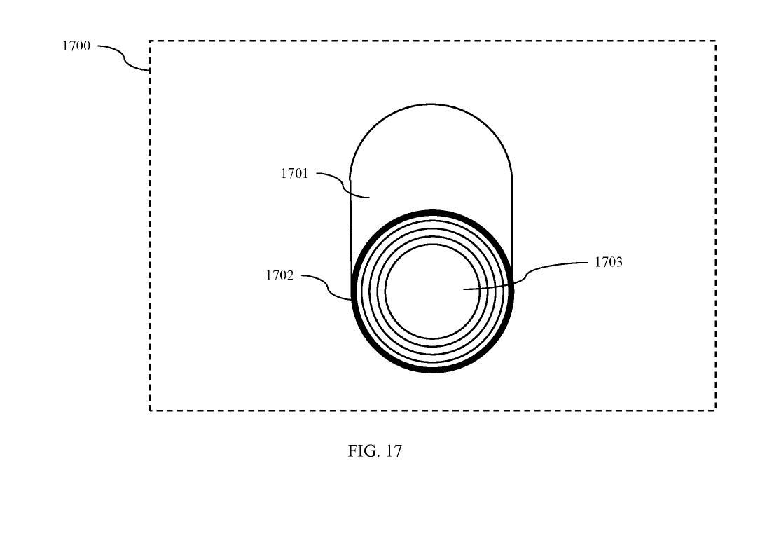

Referring now to FIG. 17 there is a cross-sectional view of a vacuum attachment (1700) with a tapered section as according to one embodiment of the present invention. The vacuum attachment (1700) may have tube section (1701) with an outer wall (1702) that tapers down to accommodate vacuum tubes or hoses with a smaller diameter. Debris may be transported through the vacuum attachment (1700) by travelling in a reduced-diameter opening (1703) within the vacuum attachment (1700).

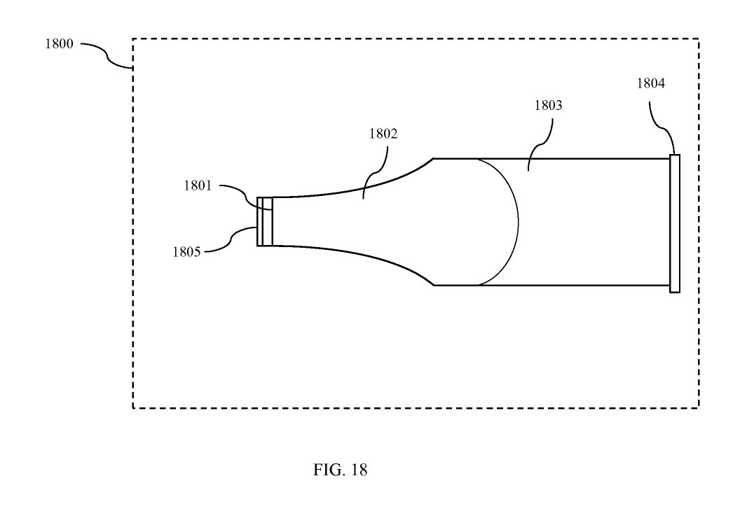

Referring now to FIG. 18, there is shown an exemplary vacuum attachment (1800) with a narrowed suction nozzle (1802) as according to one embodiment of the present invention. The narrowed suction nozzle (1802) may allow the user to reach debris that are in confined spaces otherwise not accessible with wider or larger vacuum attachments. The vacuum attachment (1800) may have an integrated or removable scraping blade (1805) for loosening stuck-on debris. The vacuum attachment (1800) may have a collar (1804) for attaching the vacuum attachment (1800) to a suction tube or hose. The vacuum attachment (1800) may have an opening (1801) through which debris are removed by suction force. A user may hold the vacuum attachment (1800) by gripping the attachment body (1802).

Some of the attached figures depict either a vacuum system attachment, or the tip of the vacuum system attachment. For those figures that depict only the tip of the vacuum system attachment, the figures are not intended to limit the scope of the invention to the depicted tip. It is implied that the figures depicting a tip of a vacuum attachment are merely showing a portion of a complete vacuum system attachment in an effort to clarify the nature of the invention. It is assumed that the tips of the vacuum attachments are integral parts of an entire vacuum system attachment and are operable to be used with the present invention.

The vacuum system attachments of the present invention may have features that, while depicted in only some of the attached images, may be found in some or all of the vacuum system attachments. These features may include a collar for attaching a vacuum system attachment to a suction tube or hose. A suction tube or hose may be physically mated to the vacuum system attachment by inserting the tube or hose into the collar section of the attachment. The features may further include a taper for accommodating smaller vacuum tubes or hoses. The taper portion of a vacuum attachment may provide an airway for transporting debris to a suction device that has a reduced internal diameter. The smaller vacuum tubes or hoses may attach to the vacuum system attachment by mating directly to the reduced diameter tapered portion. However, the present invention may be implemented without the use of the aforementioned collar or taper sections.

Certain configurations of vacuum system attachments have been shown with specific types of blades or tips. By way of example, FIGS. 7A and 7B show a curved vacuum system attachment with an integrated or removable blade while FIGS. 5A and 5B show a vacuum attachment tip with a serrated scraping blade. The figures are not intended to limit the types of blades used on each attachment. Namely, each vacuum system attachment may use any of the blades described herein or shown in the accompanying images. Each vacuum system attachment may use a scraping blade, a serrated blade, a thick blade, a thin blade, a razor blade, a corner-scraping blade, an inverted blade, a blade that is fanned, a narrowed blade, a flat blade with scraping holes, a corner-scraping blade with holes, or any other blade mentioned herein. Furthermore, each blade used by the vacuum system attachment may be removable or permanently attached. The blades may also be made of plastic, metal, or any other material as is appropriate.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A vacuum attachment system comprising:
a plurality of vacuum attachments for removing debris wherein each vacuum attachment is adapted for a particular purpose; each vacuum attachment has an integrated or separable scraping blade for removing debris; each vacuum attachment has an opening through which debris travels to a vacuum device; each vacuum attachment has an attachment body where a user can hold the attachment; and each vacuum attachment can be attached to a suction hose or a suction tube that connects said vacuum attachments to the vacuum device.

2. The vacuum attachment system of claim 1, wherein the vacuum attachments are adapted to be used for automotive cleaning purposes.

3. The vacuum attachment system of claim 1, wherein the vacuum attachments are adapted to be used for residential cleaning purposes.

4. The vacuum attachment system of claim 1, wherein the vacuum attachments are adapted to be used for construction cleaning purposes.

5. The vacuum attachment system of claim 1, wherein the vacuum attachments are adapted to be used for residential cleaning purposes.

6. The vacuum attachment system of claim 1, wherein the separable scraping blade is a razor blade.

7. The vacuum attachment system of claim 1, wherein the vacuum attachments may be attached to a shop-vac, a traditional vacuum cleaner, or a building's vacuum system.

8. A method for cleaning comprising:
providing a vacuum attachment system that contains a plurality of vacuum attachments wherein each vacuum attachment is intended to be used for a particular cleaning purpose; each vacuum attachment may be attached to a vacuum device; and allowing users to select a vacuum attachment from the plurality of vacuum attachments in order to perform a particular cleaning purpose.

9. The method of claim 8, wherein a detachable scraping blade is attached to some or all of the vacuum attachments.

10. The method of claim 8, wherein a scraping blade is integrated into some or all of the vacuum attachments.

11. The method of claim 8, wherein the vacuum attachments can be used for residential, commercial, construction, or automotive cleaning purposes.

12. The method of claim 8, wherein the vacuum device is a shop-vac, a traditional vacuum cleaner, or a building vacuum system.

13. The method of claim 8, wherein the vacuum attachments can be attached to a vacuum hose.

14. The method of claim 8, wherein the vacuum attachments can be attached to a vacuum tube.

15. A vacuum attachment comprising:
a vacuum attachment tip that has been adapted for a particular cleaning purpose; a vacuum attachment housing; an opening through which debris is transported to a vacuum device; and an integrated or removable scraping blade for loosening debris.

16. The vacuum attachment of claim 15, wherein the vacuum attachment tip has been adapted for automotive cleaning purposes.

17. The vacuum attachment of claim 15, wherein the vacuum attachment tip has been adapted for residential cleaning purposes.

18. The vacuum attachment of claim 15, wherein the vacuum attachment tip has been adapted for commercial cleaning purposes.

19. The vacuum attachment of claim 15, wherein the vacuum attachment tip has been adapted for construction cleaning purposes.

20. The vacuum attachment of claim of claim 15, wherein the vacuum attachment further comprises a release mechanism for disengaging the removable scraping blade.
